(19) United States
(12) Patent Application Publication
(10) Pub. No.: US 2013/0341942 A1
(43) Pub. Date: Dec. 26, 2013

(54) CLAMP FOR HANDLING LARGE LOADS

(71) Applicant: Enrique Tichell Fortea, Castellon de la Plana (Castellon) (ES)

(72) Inventor: Enrique Tichell Fortea, Castellon de la Plana (Castellon) (ES)

(21) Appl. No.: 13/995,534

(22) PCT Filed: Dec. 13, 2011
(86) PCT No.: PCT/ES2011/070857

§ 371 Date: Sep. 12, 2013

(30) Foreign Application Priority Data
Jan. 12, 2011 (ES) P201130028

(51) Int. Cl. B66C 1/44

(52) U.S. Cl. CPC B66C 1/442
USPC 294/104

(57) ABSTRACT

The invention relates to a clamp for handling large loads. The load to be held is a prismatic block, which may be spherical or irregular and is held by the clamp at three points. The clamp has a master arm (7), which is connected by means of at least one shaft to two free arms (3), with support elements (2) which improve grip being present at both the holding end of the master arms (7) and at the holding ends of the free arms (3).

### OBJECT OF THE INVENTION

The present specification, as expressed in the wording of this specification, relates to a clamp for handling large loads, which essential purpose consists of simplifying current clamps with the reduction of pieces by using a highly original configuration having a master arm and two free arms, which greatly use the pulling force.

### BACKGROUND OF THE INVENTION

Several registrations for the lifting of large pieces are known, such as Utility Model 231.847, titled “clamp for the pick up and loading of concrete pieces”, or European Patent EP0857685 A2, titled “Load clamping and lifting apparatus”. Both registrations present configurations that are very different from the one proposed by the present invention, with two free arms and a master arm.

### DESCRIPTION OF THE INVENTION

In order to achieve the objectives and avoid the inconveniences indicated in the previous sections, the invention consists of a clamp for handling large loads, wherein the load to be held is a prismatic, spherical, or irregular block and is held by the clamp at three points.

As a novelty, according to the invention, the clamp thereof has a master arm, connected by means of shafts to two free arms with respect to the master arm and joined together with each other; there exist support elements which improve grip at both the holding end of the master arms and at the holding ends of the free arms.

In a preferred embodiment of the invention, the master arm has a opening pulley and an lifting pulley, while each one of the two free arms of the clamp has a opening pulley.

In addition, according to different embodiments of the invention, the support element is selected among the following:
a generic element joined together with conventional means to a inner part of each free arm and to an inner part of the master arm;
a conventional plate with a replaceable friction element;
a plate with a replaceable friction element and articulated by means of a shaft to the end of the corresponding arms;
an inner trimming with a shape supplementary to the load to be held, made at the arm;
an inner trimming, made at the arm, which shape is a generic tooth applicable to different edges and surfaces.

With the configuration described above, the invention presents advantages related to the use of forces that does not occur in other configurations, also using very simple means that allow the reduction of costs given that it needs less pieces and less manpower, without failing to comply with current regulations.

Next, in order to facilitate a better comprehension of this specification and being an integral part thereof, figures have been attached, which represent the object of the invention in an illustrative rather than limitative manner.

### BRIEF DESCRIPTION OF THE DRAWINGS

FIG. 1 Represents a profile and schematic view of a clamp for handling large loads according to the present invention.

FIG. 2 Shows a view analogous to the previous one, showing a real clamp and a load of a prototype made according to a preferred embodiment of the invention.

FIG. 3 Represents three views: elevated, plant, and profile of the clamp of the previous FIG. 2 applied to the holding of another load.

FIGS. 6 to 9 Show a schematic view of several variations of support elements used in the clamp of the invention.

### DESCRIPTION OF AN EXAMPLE OF THE INVENTION

Next, a description of an example of the invention shall be made by alluding to the references of the figures.

First of all, we shall provide a list with the references used in the drawings:
1: Load to be held.
2: First support element of the ends of the clamp.
2A: Second support element of the ends of the clamp.
2B: Third support element of the ends of the clamp.
2C: Fourth support element of the ends of the clamp.
2D: Fifth support element of the ends of the clamp.
3: Free arm of the clamp, schematic and general.
3A: Free arm of the clamp, schematic and according to a first variation of a real prototype.

3B: Free arm of the clamp, schematic and according to a second variation of a real prototype.
4: Opening pulley of the free arm 3.
5: Lifting pulley of the master arm 7.
6: Opening pulley of the master arm 7.
7: Master arm of the clamp.

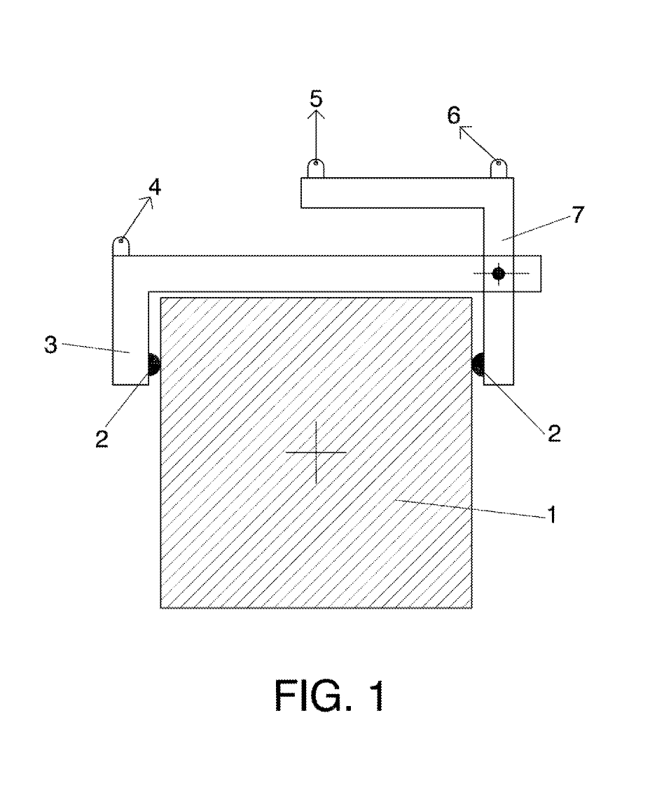

Thus, as shown in FIG. 1, the clamp of the invention is applied to a load 1, which, that could be a cubic concrete cube, as shown schematically in FIG. 1, to which two free arms 3 are applied, each of these arms having an inclined L-shape and presenting its free rotation in proximity of the free end of the larger limb, by means of an essentially horizontal shaft that relates it to a master arm 7, approximately triangle-shaped, as shown in FIG. 1.

In addition, each free arm 3 presents support elements 2 in the inner part of its shorter limb, there being another support element in the inner part of the master arm 7.

On the other hand, each free arm 3 of the clamp has an opening pulley 4 located in the outer part, corresponding to the angle of the “L”.

On the other hand, the master arm 7 has a lifting pulley 5 and an opening pulley 6.

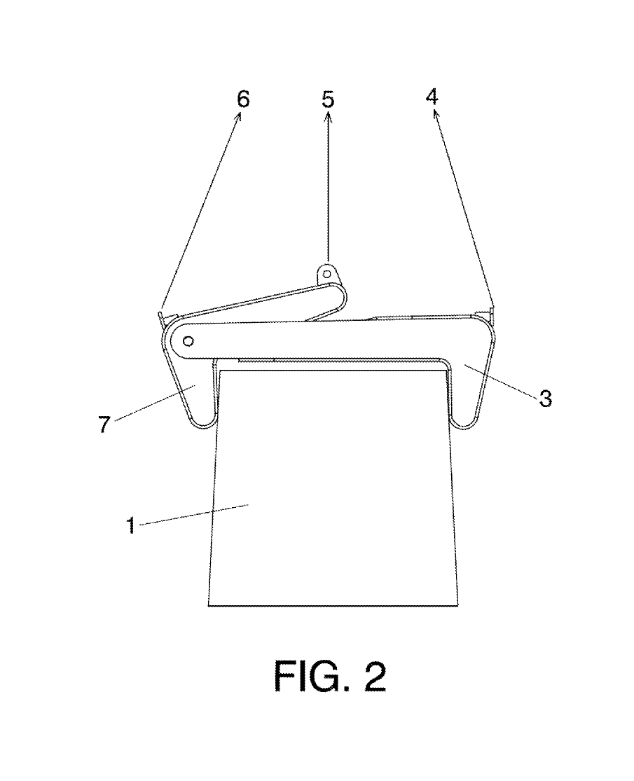

With this configuration, shown schematically in FIG. 1, when the lifting mechanism is applied to the pulley 5, an optimal distribution of forces is produced which allows holding high loads with very few pieces and with a very simple construction, even in pieces with faces converging towards the pulley, as represented in the real prototype of FIG. 2.

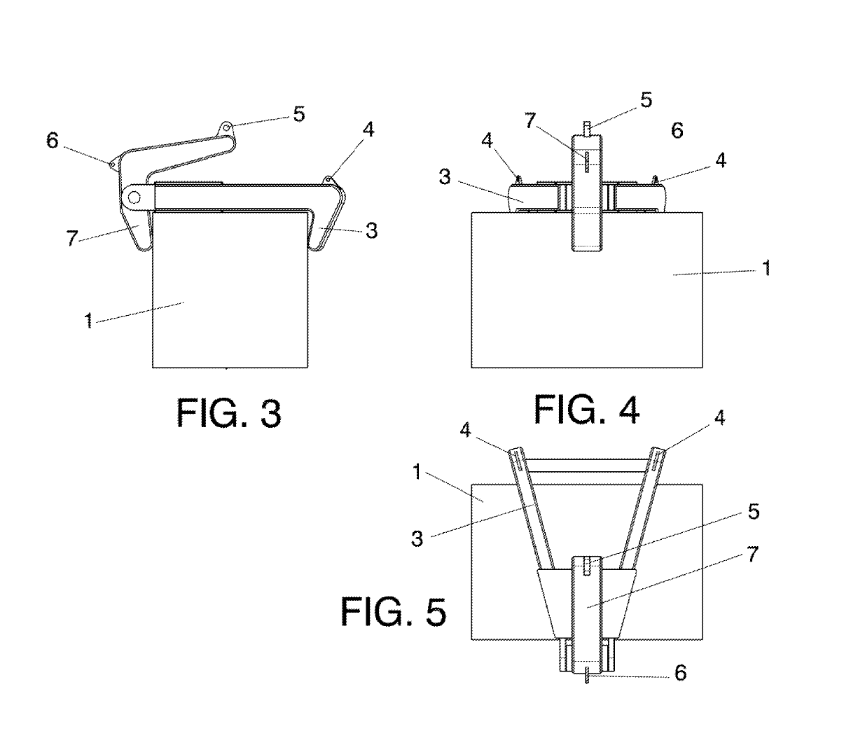

Another real prototype with more detail is shown in FIGS. 3, 4 and 5, where there exist a configuration of the free arms 3 with an approximately trapezoidal arrangement in the horizontal plane, and the master arm 7 having a slightly obtuse angling; the support elements, not referenced in these three FIGS. 3 to 5, being applied to a prismatic-rectangular block that could be made of solid steel, a packed liquid, or natural rock.

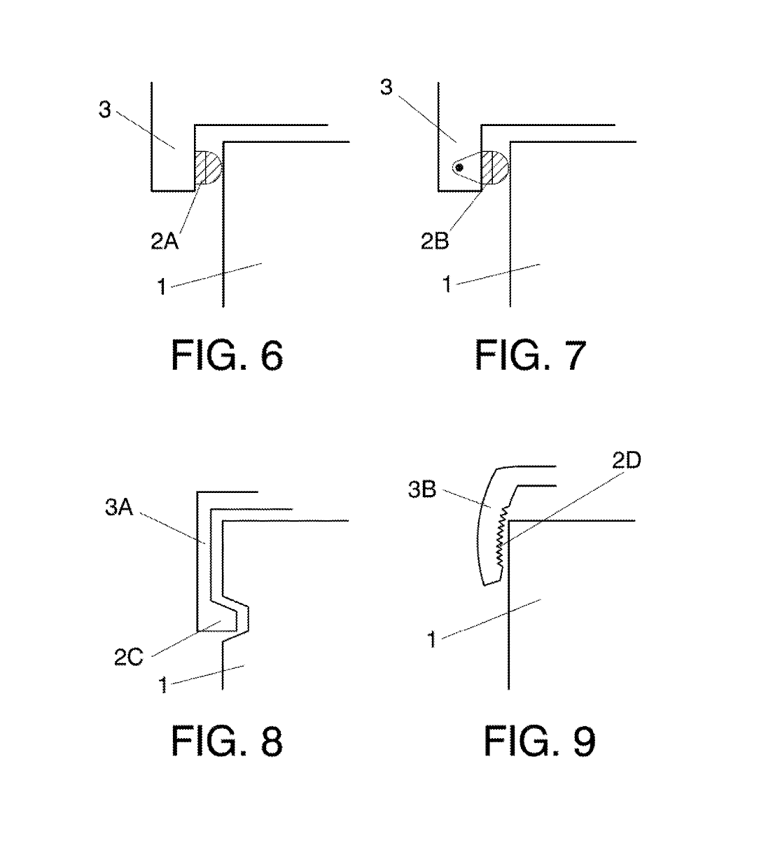

On the other hand, FIGS. 6 to 9 show variations of the support element 2, wherein we can distinguish: element 2A, consisting of a conventional plate with a replaceable friction piece; 2B consisting of a plate with a replaceable friction element and articulated by means of a shaft to the end of the corresponding arm 3; an inner trimming, 2C with a shape supplementary to the load 1 in the areas of application of the corresponding arm 3A; or, for example, an inner trimming 2D, made at the corresponding free arm 3B, which shape is a generic tooth applicable to different edges and surfaces.

By varying the length of the horizontal section of the arm 7, we may deviate the lifting point or pulley 5 from the center to be able to lift the weight with a certain inclination.

1. Clamp for handling large loads, wherein the load to be held is a prismatic, spherical, or irregular block, held by the clamp at three points; characterized in that the clamp has a master arm (7), which is connected by means of at least one shaft to two free arms (3, 3A, 3B) with respect to the master arm, and joined together with one another, with support elements (2, 2A, 2B, 2C, 2D) which improve grip being present at both the holding end of the master arm (7) and at the holding ends of the free arms (3, 3A, 3B).

2. Clamp for handling large loads according to claim 1, characterized in that the master arm (7) has an opening pulley (6) and a lifting pulley (5); while each one of the two free arms (3, 3A, 3B) of the clamp has an opening pulley (4).

3. Clamp for handling large loads according to claim 1, characterized in that each one of the support elements (2, 2A, 2B, 2C, 2D) is selected among:
a generic element (2) joined with conventional means to an inner part of each free arm (3) and to the inner part of the master arm (7);
a conventional plate with a replaceable friction piece (2A);
a plate with a replaceable friction element (2B) and articulated by means of a shaft to the end of the corresponding arm (3);
an inner trimming (2C) with a shape supplementary to the load to be held and made in the arm (3A);
an inner trimming (2D), made in the corresponding free arm (3B), which shape is a generic tooth applicable to different edges and surfaces.

4. Clamp for handling large loads according to claim 2, characterized in that each one of the support elements (2, 2A, 2B, 2C, 2D) is selected among:
a generic element (2) joined with conventional means to an inner part of each free arm (3) and to the inner part of the master arm (7);
a conventional plate with a replaceable friction piece (2A);
a plate with a replaceable friction element (2B) and articulated by means of a shaft to the end of the corresponding arm (3);
an inner trimming (2C) with a shape supplementary to the load to be held and made in the arm (3A);
an inner trimming (2D), made in the corresponding free arm (3B), which shape is a generic tooth applicable to different edges and surfaces.
